(19) United States
(12) Patent Application Publication
(10) Pub. No.: US 2007/0106618 A1
(43) Pub. Date: May 10, 2007

(54) Wireless-linked online transaction system for portable intelligent electronic device

(75) Inventors: Bo-Chen Wu, Hsinchu Hsien (TW); Der-Lin Duh, Hsinchu (TW); Tung-Hung Lu, Hsinchu (TW); Lee-Shyang Huang, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/377,203

(22) Filed: Mar. 17, 2006

(30) Foreign Application Priority Data
Nov. 8, 2005 (TW) 094139068

(51) Int. Cl. G06Q 99/00

(52) U.S. Cl. 705/64; 705/75

(57) ABSTRACT

A wireless-linked online transaction system is proposed, which is designed for use with a portable intelligent electronic device, and which is characterized by the use of an advertising-side unit embodied in the form of an RFID chip to store a set of wireless Web page data and code and mounted on an advertising medium for the purpose of allowing the user of a portable intelligent electronic device to be capable of downloading the data and code stored in the RFID chip in a wireless method into the portable intelligent electronic device, so that the user is able to carry out an online transaction procedure through the downloaded Web page. This feature allows the user to conveniently and immediately make an online transaction through his/her portable intelligent electronic device right after the user sees the advertisement of a new product or service.

### BACKGROUND OF THE INVENTION

1. Field of the Invention

This invention relates to wireless networking technology, and more particularly, to a wireless-linked online transaction system which is designed for use in conjunction with a portable intelligent electronic device, such as a palmtop computer, a notebook computer, or an intelligent mobile phone, for providing a user-operated wireless-linked online transaction capability that allows the user to utilize his/her portable intelligent electronic device to download a set of wireless Web page data and code from an advertising medium, such as poster, billboard, signboard, placard, catalog, shopping window, to name just a few, and whereupon the user is able to utilize his/her portable intelligent electronic device to browse related advertisements about the products or services exhibited on the advertising medium, and, if desired, able to carry out an online transaction procedure directly through his/her portable intelligent electronic device.

2. Description of Related Art

With the advent of the Internet technology, online shopping is nowadays a popular form of transaction between consumers and vendors. In the practice of online shopping, the consumer needs to utilize a computer platform, such as a desktop computer or a notebook computer, to connect to the Internet and link to a particular Web site that offers online shopping. Typically, the Web site will display product and price information about each item of product being sold online. If the user wants to purchase a certain item of product, the user needs just to input a set of transaction request data, including, for example, the item to be purchased, the buyer's name, shipment address, telephone number, method of payment, and so on, through the displayed Web page. The PC will then send the transaction request data via the Internet to the vendor's network server where an online transaction processing system is installed to process the user-initiated transaction request. This online transaction processing procedure includes, for example, a first step of notifying a dispatch center via network connection to send an item of the user-specified product to the user-specified address, a second step of linking to an online banking service system for processing the user-specified method of payment, such as by credit card, and so on.

One drawback to the aforesaid practice, however, is that it requires the user to know the location of the Web site where online shopping is available and then link his/her PC via the Internet to that Web site. Since new products are being introduced to the consumer market very quickly, if the consumers don't know the locations of the related Web sites, online shopping would be impossible for the consumers. When new products are introduced, vendors would typically demonstrate these products through various kinds of advertising media, such as posters, billboards, signboards, placards, catalogs, shopping windows, to name just a few. However, when a consumer sees the advertisement of a new product, for example from a poster, and wants to purchase an item of the advertised product, the consumer needs to take a note of the vendor's name or Web address shown on the poster, then utilize his/her home PC to link to the vendor's Web site for online shopping of the product. This practice is undoubtedly inconvenient and timing-consuming. There exists therefore a need for a new invention that allows the consumer to carry out an online shopping procedure immediately after the consumer sees the advertisement of a new product on a poster or billboard by way of his/her portable intelligent electronic device, such as a mobile phone or a palmtop computer.

Related art includes, for example, the following patents:
U.S. Pat. No. 6,354,493 B1 “SYSTEM AND METHOD: FOR FINDING A SPECIFIC RFID TAGGED ARTICLE LOCATED IN A PLURALITY OF RFID TAGGED ARTICLES”;
US Patent Application US2005/0116050A “MOBILE TERMINAL HAVING SMART CARD COUPLED WITH RFID TAG AND METHOD FOR PERFORMING RFID FUNCTION IN SUCH MOBILE TERMINAL”;
US Patent Application US2004/0103033A1 “RFID SYSTEM AND METHOD FOR VENDING MACHINE CONTROL”;
US Patent Application US2004/0103034A1 “RFID SYSTEM AND METHOD FOR PURCHASE ITEM ACCOUNTABILITY”;
US Patent Application US2005/0160003A1 “SYSTEM AND METHOD FOR INCREASING RFID TRANSACTION DEVICE USAGE AT A MERCHANT LOCATION”; and
US Patent Application US2003/0225713A “PREPAYMENT SYSTEM FOR POWER DISTRIBUTING USING RFID TECHNOLOGY”.

These patents respectively disclose various applications of the RFID (Radio Frequency IDentification) technology in various fields. None of these patents, however, disclose the downloading of wireless Web page data and code to a portable intelligent electronic device by means of an RFID chip.

### SUMMARY OF THE INVENTION

It is an objective of this invention to provide a wireless-linked online transaction system for portable intelligent electronic device which allows a user to be able to carry out a wireless-linked online transaction procedure by way of a portable intelligent electronic device immediately after the user sees the advertisement of a new product or service exhibited on an advertising medium.

The wireless-linked online transaction system according to the invention is designed for use in conjunction with a portable intelligent electronic device, such as a palmtop computer, a notebook computer, or an intelligent mobile phone, for providing a user-operated wireless-linked online transaction capability that allows the user to utilize his/her portable intelligent electronic device to download a set of wireless Web page data and code from an advertising medium, such as poster, billboard, signboard, placard, catalog, shopping window, to name just a few, and whereupon the user is able to utilize his/her portable intelligent electronic device to browse related advertisements about the products or services exhibited on the advertising medium, and, if desired, able to carry out an online transaction procedure directly through his/her portable intelligent electronic device.

In architecture, the wireless-linked online transaction system according to the invention comprises at least 3 distributed units: (A) an advertising-side unit; (B) a customer-side unit; and (C) a server-side unit; wherein the advertising-side unit is installed on an advertising medium, and which includes: (A1) a data storage module, which is used to store a set of wireless Web page data and code; and (A2) a wireless access interface module, which is used to provide a wireless access interface function for the customer-side unit to gain access to the wireless Web page data and code stored in the data storage module in a wireless manner; wherein the customer-side unit is installed on the intelligent electronic device, and which includes: (B1) a wireless data read module, which is capable of linking in a wireless manner to the wireless access interface module of the advertising-side unit for reading out the wireless Web page data and code stored in the data storage module of the advertising-side unit; (B2) a browser module, which is capable of displaying the contents of the wireless Web page data and code received by the wireless data read module from the advertising-side unit; and which is capable of responding to a user-initiated transaction request event to issue a corresponding transaction request message; and (B3) a wireless networking interface module, which is capable of linking the customer-side unit via a wireless network system to the server-side unit for the customer-side unit and the server-side unit to exchange data via the wireless network system; and which is capable of transmitting the transaction request message issued by the browser module via the wireless network system to the server-side unit; and wherein the server-side unit is installed on at least one network server linked to the wireless network system, and which includes: (C1) a network communication module, which is linked to the wireless network system for the server-side unit and the customer-side unit to exchange transaction data via the wireless network system; and (C2) an online transaction processing module, which is capable of responding to the transaction request message received by the network communication module from the customer-side unit by performing a corresponding online transaction processing procedure.

The wireless-linked online transaction system according to the invention is characterized by the use of an advertising-side unit embodied in the form of an RFID chip to store a set of wireless Web page data and code and mounted on an advertising medium for the purpose of allowing the user of a portable intelligent electronic device to be capable of downloading the wireless Web page data and code stored in the advertising-side unit (RFID chip) in a wireless method into the portable intelligent electronic device, so that the user is able to carry out an online transaction procedure through the downloaded Web page. This feature allows the user to conveniently and immediately make an online transaction through his/her portable intelligent electronic device right after the user sees the advertisement of a new product or service.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the networking environment where the wireless-linked online transaction system of the invention is utilized;

FIG. 2 is a schematic diagram showing the distributed architecture of the wireless-linked online transaction system according to the invention; and

FIG. 3 is a schematic diagram showing more detailed internal architecture of the wireless-linked online transaction system according to the invention.

### DETAILED DESCRIPTION OF PREFERRED EMBODIMENTS

The wireless-linked online transaction system for portable intelligent electronic device according to the invention is disclosed in full details by way of preferred embodiments in the following with reference to the accompanying drawings.

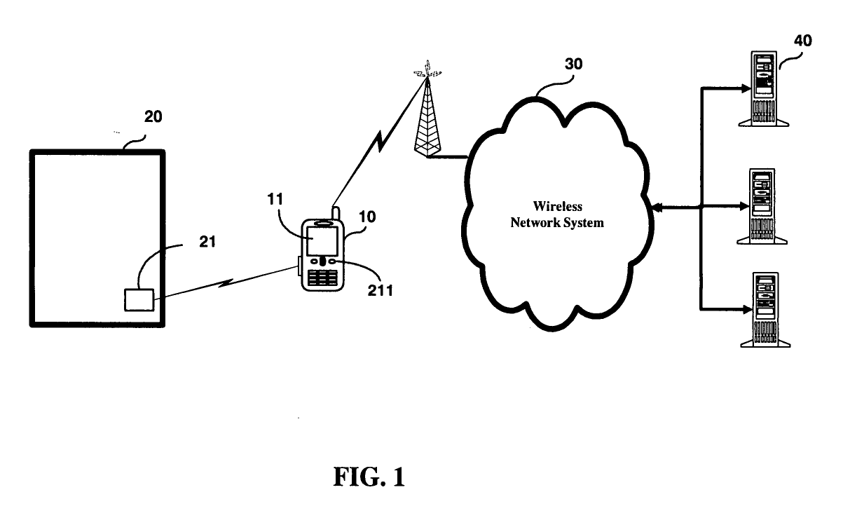

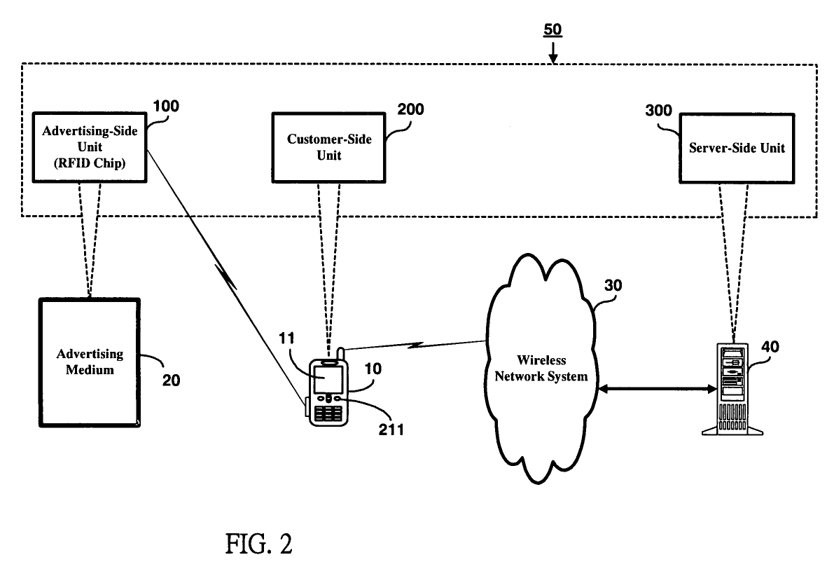

FIG. 1 and FIG. 2 are schematic diagrams showing the application and distributed architecture of the wireless-linked online transaction system according to the invention (shown in FIG. 2 as a dotted rectangular box designated by the reference numeral 50). As shown, the wireless-linked online transaction system of the invention 50 is designed for use in conjunction with a portable intelligent electronic device 10, such as a palmtop computer, a notebook computer, an intelligent mobile phone, to name just a few, for providing a user-operated wireless-linked online transaction capability that allows the user to utilize the portable intelligent electronic device 10 to download a set of wireless Web page data and code from an advertising medium 20, such as a poster, a billboard, a signboard, a placard, a catalog, a shopping window, to name just a few, and whereupon the user is able to utilize the portable intelligent electronic device 10 to browse more detailed online advertisement information about the products or activities exhibited on the advertising medium 20 and, if the user intends to make a transaction, able to immediately carry out an online transaction procedure directly through the intelligent electronic device 10. In the application of the invention on a mobile phone, the portable intelligent electronic device 10 is for example based on a WinCE Phone Edition operating system developed by Microsoft Corporation.

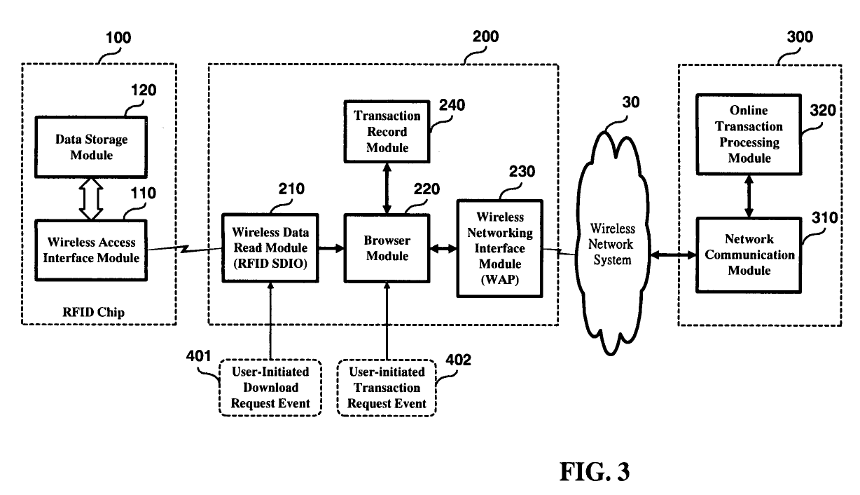

As shown in FIG. 2, the wireless-linked online transaction system of the invention 50 is based on a distributed architecture comprising at least 3 separate units: (A) an advertising-side unit 100; (B) a customer-side unit 200; and (C) a server-side unit 300; and wherein as shown in FIG. 3, the advertising-side unit 100 includes: (A1) a wireless access interface module 110; and (A2) a data storage module 120; the customer-side unit 200 includes: (B1) a wireless data read module 210; (B2) a browser module 220; and (B3) a wireless networking interface module 230; and can further optionally includes: (B4) a transaction record module 240; and the server-side unit 300 includes: (C1) a network communication module 310; and (C2) an online transaction processing module 320.

Firstly, the respective attributes and behaviors of the constituent modules 110, 120 of the advertising-side unit 100 are described in details in the following.

The advertising-side unit 100 per se is for example an RFID (Radio Frequency IDentification) compliant chip; and in accordance with the invention, the RFID chip is used to prestore a set of wireless Web page data and code about a new product or service on the consumer market, so that a potential customer can utilize an RFID reader (i.e., the SDIO wireless data read module 210 of the customer-side unit 200) installed on the portable intelligent electronic device 10 to read and download the wireless Web page data and code into the intelligent electronic device 10. Since RFID is a well-known wireless interface technology in the information industry, more detailed description thereof will not be given in this specification. In practical application, the advertising-side unit (RFID chip) 100 is mounted on a specified spot 21 on the advertising medium 20. When the user wants to download the wireless Web page data and code from the advertising-side unit (RFID chip) 100 into his/her intelligent electronic device 10, the user can simply point his/her portable intelligent electronic device 10 at the specified spot 21 where the advertising-side unit (RFID chip) 100 is mounted, and activate it to emit an RFID radio beam against the advertising-side unit (RFID chip) 100. This will cause the wireless access interface module 110 in the advertising-side unit (RFID chip) 100 to respond by retrieving the wireless Web page data and code stored in the data storage module 120 and transmitting the retrieved data and code back to the portable intelligent electronic device 10.

Next, the respective attributes and behaviors of the constituent modules 210, 220, 230, 240 of the customer-side unit 200 are described in details in the following.

The wireless data read module 210 is for example an SDIO (Secure Digital Input/Output) compliant interface module, which is capable of responding to a user-initiated download request event 401 (for example, an event of the user pressing a hot key 211 on the portable intelligent electronic device 10) by emitting an RFID radio signal in a user-aimed direction toward the advertising-side unit (RFID chip) 100, and after that is capable of receiving the returned RFID signal from the advertising-side unit (RFID chip) 100, where the returned RFID signal carries the wireless Web page data and code stored in the advertising-side unit (RFID chip) 100. Since SDIO is a well-known RFID interface standard in the information industry, more detailed description thereof will not be given in this specification. In practical implementation, for example, the hot key 211 can be either a physical button on the control panel of the portable intelligent electronic device 10, or an on-screen graphic button displayed on the screen 11.

The browser module 220 can be, for example, the built-in Web browser program in WinCE Phone Edition operating system or a third-party Web browser program, which is capable of providing a user-operated browsing function to display the contents of the wireless Web page data and code received by the wireless data read module 210 from the advertising-side unit (RFID chip) 100; and which is further capable of responding to a user-initiated transaction request event 402 (i.e., an event of the user issuing a transaction request through the Web page downloaded from the advertising-side unit 100) by issuing a corresponding transaction request message.

The wireless networking interface module 230 is for example a WAP (Wireless Application Protocol) compliant wireless interface module, which is capable of linking the customer-side unit 200 via a wireless network system 30 to the server-side unit 300 for the customer-side unit 200 and the server-side unit 300 to exchange data via the wireless network system 30, i.e., the wireless networking interface module 230 is capable of transmitting the transaction request message issued by the browser module 220 via the wireless network system 30 to the server-side unit 300, and is further capable of receiving responses from the server-side unit 300 via the wireless network system 30.

The transaction record module 240 is capable of recording a set of related transaction data about each online transaction procedure carried out by the user with the customer-side unit 200 on the intelligent electronic device 10 by means of the wireless Web page data and code downloaded from the advertising-side unit (RFID chip) 100. If the user has utilized the wireless-linked online transaction system of the invention 50 to purchase an item of commodity but later want to return the purchased item, the data stored in this transaction record module 240 can be used by the vendor for verification purposes.

Subsequently, the respective attributes and behaviors of the constituent modules 310, 320 of the server-side unit 300 are described in details in the following.

The network communication module 310 is installed on the server 40, and which is linked to the wireless network system 30 for the server-side unit 300 and the customer-side unit 200 to exchange transaction data via the wireless network system 30.

The online transaction processing module 320 is for example an online shopping system which includes, for example, a shipment handling system, a banking service system, a logistic service system, a tracking system, a customer database system, to name a few; and which is capable of responding to the transaction request message received by the network communication module 310 from the customer-side unit 200 by performing a corresponding online transaction processing procedure. In practical implementation, this online transaction processing module 320 is similar in architecture and functionality to most existing online shopping systems, so that detailed description thereof will not be given in this specification.

The following is a detailed description of an example of a practical application of the wireless-linked online transaction system of the invention 50 in actual utilization by a user. In this application example, it is assumed that the advertising medium 20 is an advertising poster that exhibits a new product, and the user of the portable intelligent electronic device 10, after reading the contents of the advertising medium 20, wants to purchase an item of the advertised product through an online method.

Referring to FIG. 1 through FIG. 3 together, in the above-mentioned case, the user needs first to switch on his/her portable intelligent electronic device 10 (which can be either a mobile phone, a palmtop computer, or a notebook computer), and then aim the SDIO wireless data read module 210 installed on the portable intelligent electronic device 10 directly at a specified spot 210 on the advertising medium 20 where the advertising-side unit (RFID chip) 100 is mounted, and then press the hot key 211 on the portable intelligent electronic device 10 to initiate a user-operated download request event 401. This will cause the SDIO wireless data read module 210 to respond by emitting an RFID radio signal toward the advertising-side unit (RFID chip) 100, which will cause the wireless access interface module 110 in the advertising-side unit (RFID chip) 100 to respond by retrieving the wireless Web page data and code stored in the data storage module 120 and then transmitting the retrieved data and code in RFID signal back to the SDIO wireless data read module 210:

When the SDIO wireless data read module 210 receives the RFID signal of the wireless Web page data and code from the advertising-side unit (RFID chip) 100, it will activate the browser module 220 to display the contents of the wireless Web page data and code on the screen 11 of the portable intelligent electronic device 10 for the user to browse the advertisement information and online purchase instructions related to the product exhibited on the advertising medium 20. If the user wants to purchase an item of the advertised product, the user can simply initiate a transaction request event 402 by inputting a set of transaction data, including, for example, the user's name, shipment address, telephone number, method of payment, and so on, through the displayed Web page downloaded from the advertising-side unit (RFID chip) 100.

As the user completes the inputting of required transaction data, it will cause the Web page displayed by the browser module 220 to respond by issuing a corresponding transaction request message which is then transmitted by the wireless networking interface module 230 via the wireless network system 30 to the vendor's server 40.

The wireless networking interface module 230 is for example a WAP (Wireless Application Protocol) compliant wireless interface module, which is capable of linking the customer-side unit 200 via a wireless network system 30 to the server-side unit 300 for the customer-side unit 200 and the server-side unit 300 to exchange data via the wireless network system 30, i.e., the wireless networking interface module 230 is capable of transmitting the transaction request message issued by the browser module 220 via the wireless network system 30 to the server-side unit 300, and is further capable of receiving responses from the server-side unit 300 via the wireless network system 30.

On the vendor's side, when the server 40 receives the transaction request message via the wireless network system 30 from the user's portable intelligent electronic device 10, the network communication module 310 will transfer the received transaction request message to the online transaction processing module 320, where an online transaction processing procedure is performed to process the user-initiated transaction request. This online transaction processing procedure includes, for example, a first step of notifying a dispatch center via network connection to send an item of the user-specified product to the user-specified address, a second step of linking to an online banking service system for processing the user-specified method of payment, such as by credit card, and so on. This online transaction processing procedure is similar in functionality to most existing online shopping systems, so that more detailed description thereof will not be given in this specification.

When the online transaction processing module 320 of the server-side unit 300 completes the online transaction processing procedure, it will responsively issue a confirmation message and activate the network communication module 310 to send the confirmation message via the wireless network system 30 back to the portable intelligent electronic device 10, for the purpose of notifying the user that the user-requested transaction is completed and confirmed. After this, all related transaction data, including a listing of items purchased, related product information, coupons, and so on, will be stored permanently in the transaction record module 240.

After that, the user can utilize the data stored in the transaction record module 240 to track the progress of the shipment of the purchased product by the vendor. Since the tracking function utilized by the transaction record module 240 is similar in functionality to most existing online shopping systems, more detailed description thereof will not be given in this specification.

After the user has received the purchased product but is unsatisfied with the product and wants to return the purchased item, the user needs to bring the purchased product together with the portable intelligent electronic device 10 to a vendor site, where the data stored in the transaction record module 240 can be read out by the vendor for verification purposes, i.e., to verify the identity of the user, the returned product, and the portable intelligent electronic device 10 which was used to perform the online transaction procedure.

In conclusion, the invention provides a wireless-linked online transaction system which is designed for use with a portable intelligent electronic device for providing a user-operated wireless-linked online transaction capability, and which is characterized by the use of an advertising-side unit embodied in the form of an RFID chip to store a set of wireless Web page data and code and mounted on an advertising medium for the purpose of allowing the user of a portable intelligent electronic device to be capable of downloading the wireless Web page data and code stored in the advertising-side unit (RFID chip) in a wireless method into the portable intelligent electronic device, so that the user is able to carry out an online transaction procedure through the downloaded Web page. This feature allows the user to conveniently and immediately make an online transaction through his/her portable intelligent electronic device right after the user sees the advertisement of a new product or service. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass- all such modifications and similar arrangements.

What is claimed is:

1. A wireless-linked online transaction system for use with an intelligent electronic device for providing a user-operated wireless-linked online transaction capability, which comprises:
an advertising-side unit, which is installed on an advertising medium, and which is used to store a set of wireless Web page data and code that are capable of being accessed through external wireless activation; and
a customer-side unit, which is installed on the intelligent electronic device, and which is capable of retrieving and downloading the wireless Web page data and code stored in the advertising-side unit through external wireless activation, and further capable of providing a user-operated browsing function for displaying the downloaded wireless Web page data and code.

2. The wireless-linked online transaction system of claim 1, wherein the intelligent electronic device is a palmtop computer, a notebook computer, or an intelligent mobile phone unit.

3. The wireless-linked online transaction system of claim 1, wherein the advertising medium is a poster, a billboard, a signboard, a placard, a catalog, or a shopping window.

4. The wireless-linked online transaction system of claim 1, wherein the advertising-side unit is an RFID (Radio Frequency IDentification) compliant chip.

5. The wireless-linked online transaction system of claim 1, wherein the customer-side unit includes:
a wireless data read module, which is capable of linking in a wireless manner to the wireless access interface module of the advertising-side unit for reading out the wireless Web page data and code stored in the data storage module of the advertising-side unit;
a browser module, which is capable of displaying the contents of the wireless Web page data and code received by the wireless data read module from the advertising-side unit; and which is capable of responding to a user-initiated transaction request event to issue a corresponding transaction request message; and
a wireless networking interface module, which is capable of linking the customer-side unit via a wireless network system to the server-side unit for the customer-side unit and the server-side unit to exchange data via the wireless network system; and which is capable of transmitting the transaction request message issued by the browser module via the wireless network system to the server-side unit.

6. The wireless-linked online transaction system of claim 5, wherein the wireless data read module in the customer-side unit is an SDIO (Secure Digital Input/Output) compliant interface module.

7. The wireless-linked online transaction system of claim 5, wherein the wireless networking interface module in the customer-side unit is a WAP (Wireless Application Protocol) compliant interface module.

8. The wireless-linked online transaction system of claim 5, wherein the customer-side unit further includes:
a transaction record module, which is capable of recording a set of related transaction data about each online transaction procedure carried out by the customer-side unit on the intelligent electronic device.

9. The wireless-linked online transaction system of claim 1, further comprising:
a server-side unit, which is capable of being linked to the intelligent electronic device via a wireless network system for providing the intelligent electronic device with an online transaction function.

10. The wireless-linked online transaction system of claim 9, wherein the server-side unit includes:
a network communication module, which is linked to the wireless network system for the server-side unit and the customer-side unit to exchange transaction data via the wireless network system; and
an online transaction processing module, which is capable of responding to the transaction request message received by the network communication module from the customer-side unit by performing a corresponding online transaction processing procedure.

11. A wireless-linked online transaction system for use with an intelligent electronic device for providing a user-operated wireless-linked online transaction capability, which comprises:
an advertising-side unit, which is installed on an advertising medium, and which is used to store a set of wireless Web page data and code that are capable of being accessed through external wireless activation;
a customer-side unit, which is installed on the intelligent electronic device, and which is capable of retrieving and downloading the wireless Web page data and code stored in the advertising-side unit through external wireless activation, and further capable of providing a user-operated browsing function for displaying the downloaded wireless Web page data and code; and
a server-side unit, which is capable of being linked to the customer-side unit installed on the intelligent electronic device via a wireless network system for providing the intelligent electronic device with an online transaction function.

12. The wireless-linked online transaction system of claim 11, wherein the intelligent electronic device is a palmtop computer, a notebook computer, or an intelligent mobile phone unit.

13. The wireless-linked online transaction system of claim 11, wherein the advertising medium is a poster, a billboard, a signboard, a placard, a catalog, or a shopping window.

14. The wireless-linked online transaction system of claim 11, wherein the advertising-side unit is an RFID (Radio Frequency IDentification) compliant chip.

15. The wireless-linked online transaction system of claim 11, wherein the customer-side unit includes:
a wireless data read module, which is capable of linking in a wireless manner to the wireless access interface module of the advertising-side unit for reading out the wireless Web page data and code stored in the data storage module of the advertising-side unit;
a browser module, which is capable of displaying the contents of the wireless Web page data and code received by the wireless data read module from the advertising-side unit; and which is capable of responding to a user-initiated transaction request event to issue a corresponding transaction request message; and
a wireless networking interface module, which is capable of linking the customer-side unit via a wireless network system to the server-side unit for the customer-side unit and the server-side unit to exchange data via the wireless network system; and which is capable of transmitting the transaction request message issued by the browser module via the wireless network system to the server-side unit.

16. The wireless-linked online transaction system of claim 15, wherein the wireless data read module in the customer-side unit is an SDIO (Secure Digital Input/Output) compliant interface module.

17. The wireless-linked online transaction system of claim 15, wherein the wireless networking interface module in the customer-side unit is a WAP (Wireless Application Protocol) compliant interface module.

18. The wireless-linked online transaction system of claim 15, wherein the customer-side unit further includes:
a transaction record module, which is capable of recording a set of related transaction data about each online transaction procedure carried out by the customer-side unit on the intelligent electronic device.

19. The wireless-linked online transaction system of claim 9, wherein the server-side unit includes:
a network communication module, which is linked to the wireless network system for the server-side unit and the customer-side unit to exchange transaction data via the wireless network system; and
an online transaction processing module, which is capable of responding to the transaction request message received by the network communication module from the customer-side unit by performing a corresponding online transaction processing procedure.
